(19) United States
(12) Patent Application Publication
(10) Pub. No.: US 2015/0205580 A1
(43) Pub. Date: Jul. 23, 2015

(54) Method and System for Sorting Online Videos of a Search

(71) Applicant: 1Verge Internet Technology (Beijing)Co., Ltd., Beijing (CN)

(72) Inventors: Xiuguang Tan, Beijing (CN); Jian Yao, Beijing (CN); Yuzong Yin, Beijing (CN); Wei Lu, Beijing (CN); Baiyu Pan, Dongfang City (CN); Shuqi Lu, Beijing (CN)

(21) Appl. No.: 14/420,889

(22) PCT Filed: Aug. 30, 2013
(86) PCT No.: PCT/CN2013/082741

§ 371 Date: Feb. 10, 2015

(30) Foreign Application Priority Data
Oct. 8, 2012 (CN) 201210377497.X

(51) Int. Cl. G06F 7/36; G06F 17/30

(52) U.S. Cl. CPC G06F 7/36; G06F 17/30843; G06F 17/30849

(57) ABSTRACT

Disclosed herein is a method and system for sorting network videos as a result of an online search. Under the present invention, the system obtains a final sorting factor by calculating weight values of different dimensions, including the release time of a network video, the amount of playbacks of the network video, the classification of the network video and a probability j indicating how often the network video occurs in a collection V. By presenting the videos more needed by the user on the top of a web page, the present invention provides a more accurate display of the search results, thereby improving the user viewing experience.

### FIELD OF THE INVENTION

The present invention generally relates to the field of online video search, and more particularly, to a method and system for sorting search results of an online video search.

### BACKGROUND

When users perform a search for certain videos over the Internet, the search results are usually displayed as a series of online videos sorted in accordance with a given sorting algorithm of the search engine. However, the sorting order may not correspond to each individual user's interest of search. The Chinese Patent Application Serial No. 201010200736.5, applied by ZTE Corporation, discloses a personalized meta-search method and application terminal thereof, which extracts a use log from a database of search interests based on the search keyword and pre-processes search results returned by the search engine, then, by use of the use log, calculates the degrees of interests of the pre-processed search results and the Uniform Resource Locators (URLs) in the interest database corresponding to the search keyword, and finally, sorting the search results and URLs based on the calculated results. The key of that patent application is to calculate degrees of interests in order to obtain a final sequencing results. The present invention provides a different method and system for sorting searched network videos by calculating weight values of different dimensions, which places the search results more needed by users in the top of a web page, thereby providing a more accurate display of the user-desired search results and improved viewing experience.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

In view of the problems in the existing art, one embodiment of the invention provides a method for sorting network videos resulting from a search, which comprises the steps of: receiving a search keyword by a user to search network videos; receiving one or more logs by a log system, wherein each log records one or more network videos clicked by the user from the searched network videos; based on the received logs, generating a collection V comprising the search keyword K and its corresponding network videos clicked by the user; calculating a weight value of release times of the network videos in the collection V, a weight value of the amount of playbacks of the network videos in the collection V, a weight value of classifications of the network videos in the collection V and a probability j indicating how many times the same network video occurs in the collection V; and sorting the searched network videos based on the value of a sorting factor r of each searched network video, wherein r=the release time of a network video×the weight value of the release time+the amount of playbacks of a network video×the weight value of the amount of playbacks+the weight value of the classifications of network video+j.

In one embodiment, the weight value of the release times of the network videos is calculated by: converting the release times of the network videos in the collection V into an integer relative to the current time in the units of seconds to generate a collection T comprising t1, t2, t3, . . . , tn; and calculating probabilities p1, p2, p3, wherein p1 is the probability of the times in the collection T smaller than 1 day from the current time, p2 is the probability of the times in the collection T smaller than 7 days from the current time, and p3 is the probability of the times in the collection T smaller than 30 days from the current time, wherein the weight value of the release times in the sorting factor is p=( 1/30×p1+ 1/7×p2+p3)/t, wherein t is an average of the release time in the collection T.

In one embodiment, the weight value of the amounts of playbacks of network videos is calculated by: for the amounts v1, v2, v3, . . . , vn of playbacks of every network video in the collection V, calculating a standard deviation of the amount of playbacks using the following formula:

$$a = \sqrt{\frac{1}{N} {\sum }_{i = 1}^{N} {( vi \vert v )}^{2}}$$

wherein, v is an average of the amount of playbacks, and the weight value of the amount of playbacks in the sorting factor is 1/(a×v).

In another embodiment, the weight value of the classifications of the network videos is calculated by: for the search keyword K, identifying the number of times S that the search keyword K occurs in the titles of all network videos and the number of times C that the search keyword K occurs in the network videos of a classification A; and calculating C/S as the probability that the search keyword belongs to the classification A, wherein C/S is the weight value of the classifications of network videos.

In yet another embodiment, j is calculated by: recording the number of times c that the same network video occurs in the collection v, wherein j is equal to the number of times c divided by the times of network videos occurring in the collection v; and deleting duplicate videos in the collection V.

Another embodiment of the present invention provides a system for sorting network videos resulting from a search, the system comprising: a search module for searching network videos based on a search keyword inputted by a user; a log system for collecting one or more logs of network videos clicked by the user amongst the searched network videos in response to the search keyword, and based on the logs, generating a collection V comprising the search word K and its corresponding network videos clicked by the user; a computing module for calculating a weight value of release times of the network videos in the collection V, a weight value of amounts of playbacks of the network videos, a weight value of classifications of the network videos and a probability j indicating how many times the same network video occurs in the collection V; and a sorting module for resorting the searched network videos based on a sorting factor r and displaying the resorted results, wherein r=the release time of network videos×the weight value of the release time+the amount of playbacks of network videos×the weight value of the amount of playbacks+the weight value of classifications of network videos+j.

In one embodiment, the computing module calculates the weight value of the release times of network videos by: converting the release times of the network videos in the collection V into an integer relative to the current time in the unit of seconds to generate a collection T comprising t1, t2, t3, . . . , tn; and calculating probabilities p1, p2, p3, wherein p1 is the probability of the times in the collection T smaller than 1 day from the current time, p2 is the probability of the times in the collection T smaller than 7 days from the current time, and p3 is the probability of the times in the collection T smaller than 30 days from the current time, wherein the weight value of the release times in the sorting factor is p=( 1/30×p1+ 1/7×p2+p3)/t, wherein t is an average of the release time in the collection T.

In another embodiment, the computing module calculates the weight value of the amounts of playbacks of the network videos by: for the amounts v1, v2, v3, . . . , vn of playbacks of every network video in the collection V, calculating a standard deviation of the amount of playbacks using the following formula:

$$a = \sqrt{\frac{1}{N} {\sum }_{i = 1}^{N} {( vi \vert v )}^{2}}$$

wherein, v is an average of the amounts of playbacks, and the weight of the amount of playbacks in the sorting factor is 1/(a×v).

Also, in one embodiment, the computing module calculates the weight value of the classifications of the network videos by: for the search keyword K, identifying the number of times S that the search keyword K occurs in the titles of all network videos and the number of times C that the search keyword K occurs in the network videos of a classification A; and calculating C/S as the probability that the search keyword belongs to the classification A, wherein C/S is the weight value of the classifications of network videos.

In another embodiment, the computing module calculates the probability j by: recording the number of times c that the same network video occurs in the collection v, wherein j is equal to the number of times c divided by the times of network videos occurring in the collection v; and deleting duplicate videos in the collection V.

Embodiments of the present invention provide the following advantage: by calculating weight values of different dimensions, the present invention places the search results more needed by users in the top of a web page, thereby providing a more accurate display of the user-desired search results and improved viewing experience.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a flow diagram of the video sorting algorithm in the disclosed method according to embodiments of the present invention;

FIG. 2 is a structural schematic diagram of the video search and sorting system according to embodiments of the present invention.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, embodiments of the present invention are not intended to be limited to the examples described herein and shown, but is to be accorded the scope consistent with the claims.

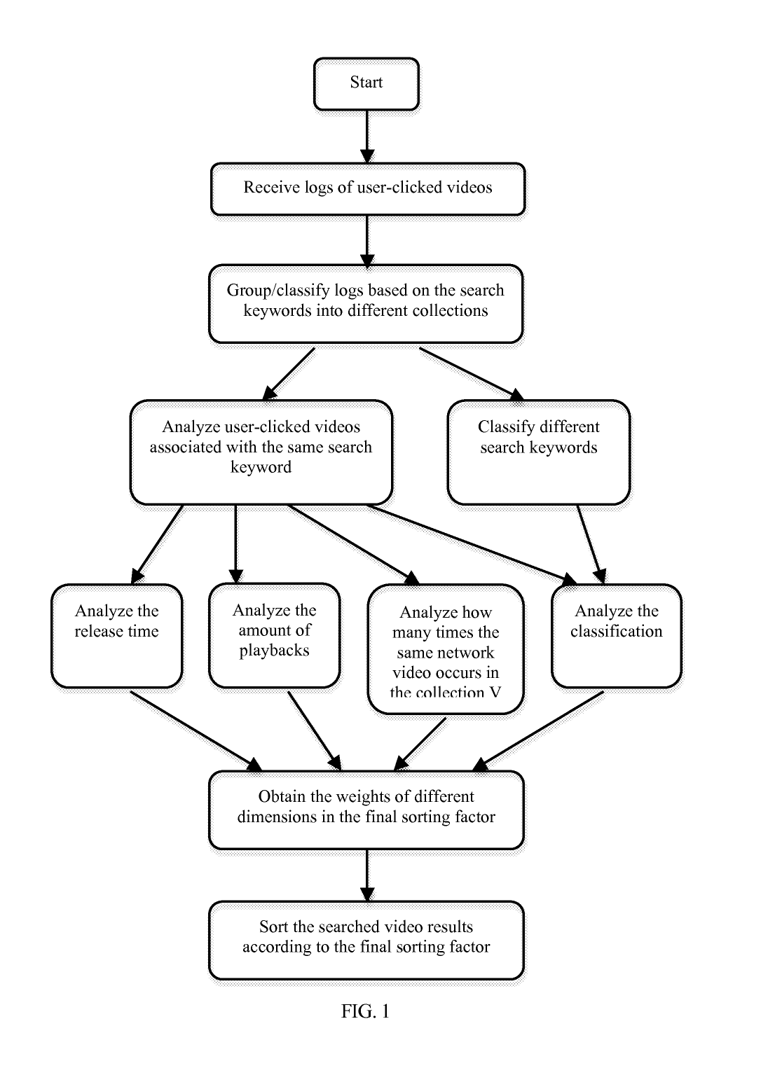

FIG. 1 is a flow diagram of the video sorting algorithm in the disclosed method according to embodiments of the present invention. As shown in FIG. 1, the following steps are performed in accordance with embodiments of the invention:

1. Information Collection with Regard to Each Search Keyword and its Corresponding User-Clicked Online Videos

In response to a user input of a search keyword through the search engine, multiple video results corresponding to the search keyword are displayed in a web page. From these displayed search results, the user can further filter out the ones he/she needs. Thereafter, when the user clicks on any of these filtered videos to watch, the system sends to a log system on the back end a log that records the user-entered search keyword and the user-clicked network videos. The log system on the back end receives and records this log. When the total number of received logs reaches a certain threshold, the log system analyzes all received logs. For example, the analysis can be conducted once a day for efficiency reasons. The process of log analysis works as follows: since each log records a search keyword and its corresponding user-clicked network videos, the first step is to retrieve all the user-clicked network videos associated with the search keyword. To the end, all user click data are grouped based on the search keywords to form a group or collection V. Each collection V includes a search keyword K and its corresponding user-clicked network videos. The network video data in each collection V is analyzed from four dimensions, including the release time, the amount of playbacks, the classification of each network video, and how many times the same network video occurs in the collection V.

2. Data Analysis of the Collected Information to Calculate Different Weight Values

1) First, the release time of network videos. At the outset, the release time of each network video in the collection V is converted into an integer relative to the current time in the unit of seconds, which results in a collection T comprising t1, t2, t3, . . . tn. Then, the probabilities of the times in the collection T smaller than 1 day, 7 days and 30 days from the current time, e.g., p1, p2, p3, are calculated, respectively. The weight value of the release time in the final sorting factor is: p=( 1/30×p1+ 1/7×p2+p3)/t (t is the average of all the release times in the collection T).

2) Second, the amount of playbacks of network videos. The following formula is used to calculate the standard deviation of the amounts of playbacks of every network video in the collection V, i.e., v1, v2, v3 . . . vn:

$$a = \sqrt{\frac{1}{N} {\sum }_{i = 1}^{N} {( vi \vert v )}^{2}}$$

wherein, v is the average of the amounts of playbacks, and the amount of playbacks of every network video is divided by the average of the amounts of playbacks. The weight value of the amount of playbacks in the final sorting factor is 1/(a×v).

3) Third, the classification of network videos. The weight of the classification of network videos in the final sorting factor is the probability k that the search keyword K falls in the classification. For a given search keyword K, the system records the number of times S that the word K appears in the title lines of all the network videos and the number of times C that the word K appears in the network videos in the classification A. As such, C/S represents the probability that the search keyword K falls in the classification A, which is the weight value of the classification of network videos in the final sorting factor.

4) Fourth, the number of occurrences of the same network video in the collection V. This number is converted into the probability j that indicates how many times the same network video occurs in the collection V, wherein j is equal to the number of occurrences of the network video in the collection C divided by the number of network videos in the collection W. At the same time, duplications in the collection V are deleted.

According to the above-calculated results of 1), 2), 3) and 4), the search results M corresponding to the search keyword K are resorted. The final sorting factor of every network video is: r=the release time of the network video×the weight value of the release time+the amount of playbacks of the network video×the weight value of the amount of playbacks+the weight value of classification to which the network video belongs+j.

Based on the values of the sorting factor r, the initial video search results are resorted in different orders for different search keywords.

3. Display Play Lists in a Web Page

The displayed contents by the system include: the screenshot, length, title and amount of playbacks of every network video, a delete button (for removing corresponding network videos from the play list), and a play button (for successively playing the contents in the play list). The contents displayed by the system are not search results, but a complement of the search results. Usually the play lists are displayed in the top right corner of the web page, which would not affect the normal display of search results and instead make full use of the unused part of the web page.

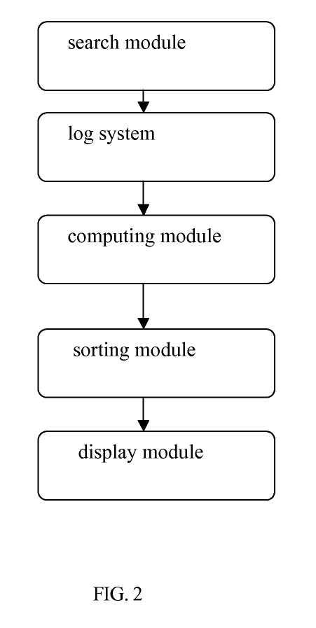

FIG. 2 is a structural schematic diagram of the video search and sorting system according to embodiments of the present invention. As shown in FIG. 2, embodiments of the present invention also provide a system for sorting searched network videos. The system comprises:

a search module for searching network videos based on a search keyword inputted by a user;

a log system for receiving logs that record user-clicked-and-watched network videos which the user chooses to click and watch, and generating a collection V comprising a search keyword K and its corresponding user-clicked network videos;

a computing module for calculating a weight value of the release time of network videos, a weight value of the amount of playbacks of network videos, a weight value of classifications of network videos and a probability j indicating how many times the same network video occurs in the collection V;

a sorting module for, based on the value of the sorting factor r, sorting different network videos corresponding to the search keyword, wherein r=the release time of network videos×the weight value of the release time+the amount of playbacks of network videos×the weight value of the amount of playbacks+the weight value of classifications of network videos+j;

a display module for displaying the generated play lists on the web page.

The above-mentioned computing module calculates the weight value of the release time of network videos as follows: converting the release time of network videos in the collection V into an integer relative to the current time in the unit of seconds, which results in a collection T comprising t1, t2, t3, . . . , tn; then calculating the probabilities of the times in the collection T smaller than 1 day, 7 days and 30 days from the current time, e.g., p1, p2, p3, respectively. The weight value of the release time in the final sorting factor is p=( 1/30×p1+ 1/7×p2+p3)/t, wherein t is the average of the release times in the collection T.

The computing module calculates the weight value of the amount of playbacks of network videos as follows: using the following formula to calculate the standard deviation of the amounts of playbacks of every network video in the collection V, v1, v2, v3 . . . vn:

$$a = \sqrt{\frac{1}{N} {\sum }_{i = 1}^{N} {( vi \vert v )}^{2}}$$

wherein, v is the average of the amounts of playbacks, and the weight of the amount of playbacks in the final sorting factor is 1/(a×v).

The computing module calculates the weight value of classifications of network videos as follows: for a given search keyword K, recording the number of the times S that the search keyword occurs in the titles of all network videos and the number of times C that the search keyword occurs in the classification A of network videos, and C/S is the probability that the search keyword belongs to the classification A, which is the weight value of the classification of network videos.

The computing module calculates j as follows: recording the number of times c that a network video occurs in the collection v, and j is equal to the number of times c that the network video occurs in the collection divided by the amount of network videos in the collection V. At the same time, duplications are deleted in the collection V.

The present invention provides the following advantages: by calculating the weight values of different dimensions, the system can sort the video search results more accurately by listing the search results more needed by users on the top of a web page, thereby improving the user viewing experience.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

What is claimed is:

1. A method for sorting network videos resulting from a search, comprising:
receiving a search keyword by a user to search network videos;
receiving one or more logs by a log system, wherein each log records one or more network videos clicked by the user from the searched network videos;
based on the received logs, generating a collection V comprising the search keyword K and its corresponding network videos clicked by the user;
calculating a weight value of release times of the network videos in the collection V, a weight value of the amount of playbacks of the network videos in the collection V, a weight value of classifications of the network videos in the collection V and a probability j indicating how many times the same network video occurs in the collection V; and
sorting the searched network videos based on the value of a sorting factor r of each searched network video, wherein r=the release time of a network video×the weight value of the release time+the amount of playbacks of a network video×the weight value of the amount of playbacks+the weight value of the classifications of network video+j.

2. The method according to claim 1, wherein the weight value of the release times of the network videos is calculated by:
converting the release times of the network videos in the collection V into an integer relative to the current time in the units of seconds to generate a collection T comprising t1, t2, t3, . . . , tn; and
calculating probabilities p1, p2, p3, wherein p1 is the probability of the times in the collection T smaller than 1 day from the current time, p2 is the probability of the times in the collection T smaller than 7 days from the current time, and p3 is the probability of the times in the collection T smaller than 30 days from the current time,
wherein the weight value of the release times in the sorting factor is p=( 1/30×p1+ 1/7×p2+p3)/t, wherein t is an average of the release time in the collection T.

3. The method according to claim 1, wherein the weight value of the amounts of playbacks of network videos is calculated by:
for the amounts v1, v2, v3, . . . , vn of playbacks of every network video in the collection V, calculating a standard deviation of the amount of playbacks using the following formula:
$$a = \sqrt{\frac{1}{N} {\sum }_{i = 1}^{N} {( vi \vert v )}^{2}}$$
wherein, v is an average of the amount of playbacks, and the weight value of the amount of playbacks in the sorting factor is 1/(a×v).

4. The method according to claim 1, wherein the weight value of the classifications of the network videos is calculated by:
for the search keyword K, identifying the number of times S that the search keyword K occurs in the titles of all network videos and the number of times C that the search keyword K occurs in the network videos of a classification A; and
calculating C/S as the probability that the search keyword belongs to the classification A, wherein C/S is the weight value of the classifications of network videos.

5. The method according to claim 1, wherein j is calculated by:
recording the number of times c that the same network video occurs in the collection v, wherein j is equal to the number of times c divided by the times of network videos occurring in the collection v; and
deleting duplicate videos in the collection V.

6. A system for sorting network videos resulting from a search, the system comprising:
a search module for searching network videos based on a search keyword inputted by a user;
a log system for collecting one or more logs of network videos clicked by the user amongst the searched network videos in response to the search keyword, and based on the logs, generating a collection V comprising the search word K and its corresponding network videos clicked by the user;
a computing module for calculating a weight value of release times of the network videos in the collection V, a weight value of amounts of playbacks of the network videos, a weight value of classifications of the network videos and a probability j indicating how many times the same network video occurs in the collection V; and
a sorting module for resorting the searched network videos based on a sorting factor r and displaying the resorted results, wherein r=the release time of network videos×the weight value of the release time+the amount of playbacks of network videos×the weight value of the amount of playbacks+the weight value of classifications of network videos+j.

7. The system according to claim 6, wherein the computing module calculates the weight value of the release times of network videos by:
converting the release times of the network videos in the collection V into an integer relative to the current time in the unit of seconds to generate a collection T comprising t1, t2, t3, . . . , tn; and
calculating probabilities p1, p2, p3, wherein p1 is the probability of the times in the collection T smaller than 1 day from the current time, p2 is the probability of the times in the collection T smaller than 7 days from the current time, and p3 is the probability of the times in the collection T smaller than 30 days from the current time,
wherein the weight value of the release times in the sorting factor is p=( 1/30×p1+ 1/7×p2+p3)/t, wherein t is an average of the release time in the collection T.

8. The system according to claim 6, wherein the computing module calculates the weight value of the amounts of playbacks of the network videos by:
for the amounts v1, v2, v3, . . . , vn of playbacks of every network video in the collection V, calculating a standard deviation of the amount of playbacks using the following formula:
$$a = \sqrt{\frac{1}{N} {\sum }_{i = 1}^{N} {( vi \vert v )}^{2}}$$
wherein, v is an average of the amounts of playbacks, and the weight of the amount of playbacks in the sorting factor is 1/(a×v).

9. The system according to claim 6, wherein the computing module calculates the weight value of the classifications of the network videos by:
for the search keyword K, identifying the number of times S that the search keyword K occurs in the titles of all network videos and the number of times C that the search keyword K occurs in the network videos of a classification A; and
calculating C/S as the probability that the search keyword belongs to the classification A, wherein C/S is the weight value of the classifications of network videos.

10. The system according to claim 6, wherein the computing module calculates the probability j by:
recording the number of times c that the same network video occurs in the collection v, wherein j is equal to the number of times c divided by the times of network videos occurring in the collection v; and
deleting duplicate videos in the collection V.
